(19) United States
(12) Patent Application Publication
(10) Pub. No.: US 2008/0031214 A1
(43) Pub. Date: Feb. 7, 2008

(54) GSM access point realization using a UMA proxy

(76) Inventors: Mark Grayson, Maidenhead (GB); Arthur E. Feather, Monte Sereno, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/500,807

(22) Filed: Aug. 7, 2006

(51) Int. Cl. H04B 7/216

(52) U.S. Cl. 370/342

(57) ABSTRACT

In one embodiment an apparatus comprises a wireless interface operable to communicate with a mobile endpoint over one or more wireless links in one or more licensed frequency bands, the communication between the wireless interface and the mobile endpoint comprising voice information and signaling information, a network interface coupled to the wireless interface and operable to communicate with a network, the communication between the network interface and the network comprising packets comprising data representing the voice information and the signaling information, and a security module coupled to the network interface. The security module is operable to access a key associated with the apparatus and included in a removable portion of the apparatus and a key associated with a particular mobile endpoint. The particular mobile endpoint is included in an authorized subset of mobile endpoints associated with subscribers to the wireless service provider.

### FIELD OF INVENTION

This invention generally relates to wireless technology.

### BACKGROUND

The introduction of Voice over Internet Protocol (VoIP) systems allows users to use a broadband connection for telephone calls. Since many users have a broadband connection for Internet access, VoIP provides a low cost alternative (or addition) to traditional landline telephone service. For example, users who use long distance frequently may save a substantial amount of money by switching to VoIP. The past years have also seen widespread adoption of wireless technologies, such as cellular telephone technology (which operates in licensed frequency bands) and unlicensed wireless technologies such as Wi-Fi and Bluetooth (which operate at frequencies outside licensed frequency bands). Cellular telephone technology includes GSM (Global System for Mobile Communications) voice and data technology.

### BRIEF DESCRIPTION OF THE DRAWINGS

FIG. 1A is a block diagram of a dual mode system with voice data transmitted over the public IP network;

FIG. 1B is a block diagram of a dual mode system with voice data transmitted in the normal cell phone mode;

FIG. 1C is a block diagram of a portion of a normal cell phone configuration;

FIG. 2 is a block diagram of a dual system, according to some embodiments;

FIG. 3 is a block diagram of another dual mode system, according to some embodiments;

FIG. 4 shows control protocols for a system such as that shown in FIG. 3;

FIG. 5 shows a process for secure location updating; and

FIG. 6 shows the interworking between GSM and UMA for location updating.

Like reference symbols in the various drawings indicate like elements.

### DETAILED DESCRIPTION OF EXAMPLE EMBODIMENTS

One problem with existing communication systems is that different systems meet different user needs, so that many users subscribe to multiple services. For example, many households subscribe to both VoIP services for low-cost calling at home, and cell phone service in order to communicate away from the home. This adds both cost and complexity to the user's life.

In order to provide benefits of VoIP in a wireless environment, dual-mode services are emerging. These telecommunications systems are referred to as Unlicensed Mobile Access (UMA) systems or Generic Access Network (GAN) systems. They include two communication modes for a single handset (and phone number): cell phone technology and VoIP technology.

For UMA systems, a dual-mode enabled handset allows a user to place calls differently, depending on the user's location. When a user is away from his or her wireless broadband connection, the handset may be used like a typical cell phone. That is, the user accesses the GSM radio network (at the standard tariff rate). However, when the user is in range of the broadband connection, the call travels over the user's wireless broadband connection.

These dual-mode systems may provide both cost savings and simplicity for consumers. Additionally, they may provide important benefits for service providers. For example, they allow for extension of cell phone coverage beyond the limits of the service provider's cell network using the wireless device at the subscriber's location and the associated broadband connection.

Systems and techniques provided herein allow for dual-mode functionality without the need for a dual-mode enabled handset. As a result, users with other handset types may obtain the benefits of UMA functionality without the need to purchase additional equipment. This may be a substantial benefit for some consumers. The systems and techniques may also benefit service providers, since they will be able to offer more complete telecommunications services without requiring subscribers to obtain new handsets.

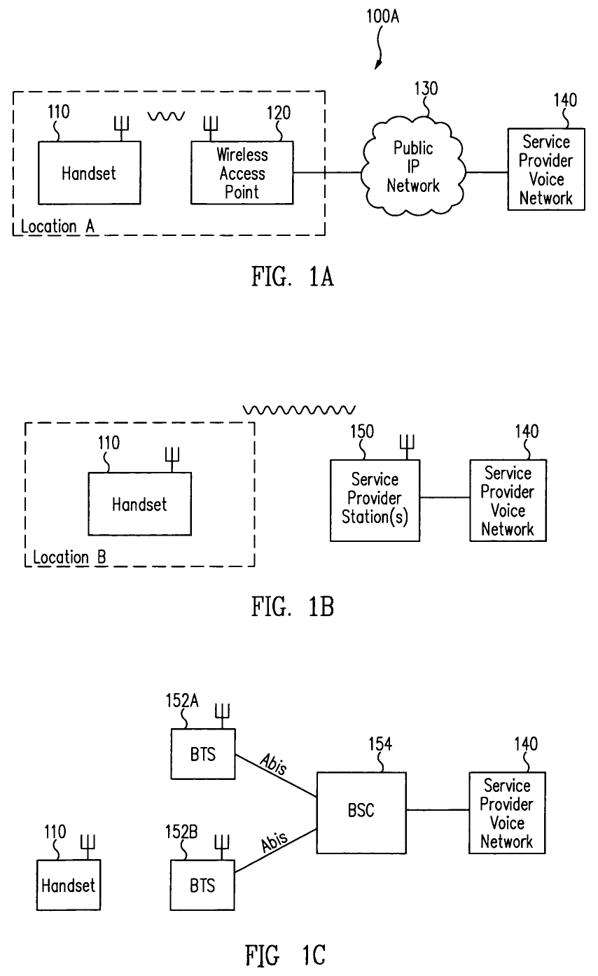

FIGS. 1A and 1B illustrate the principles of dual mode operation, for operation of a handset 110 at two different locations, A and B. At location A, handset 110 is in range of a wireless access point 120 configured to implement systems and techniques described herein. When a user initiates a call using handset 110, voice and signaling information is transmitted wirelessly to access point 120. The information is then transmitted over a broadband connection to public IP network 130, and then to the service provider's voice network 140.

By contrast, when handset 110 is not within range of wireless access point 120, the voice and signaling information is wirelessly transmitted to one or more service provider stations 150, and from there to service provider voice network 140.

As noted above, some available dual-mode systems require specially enabled handsets. Additionally, a nano-cell to proprietary IP-BSC (IP Base Station Controller) solution is available. However, because the CPE (Customer Premises Equipment) to IP-BSC link is proprietary, its integration with other systems is limited.

FIG. 1C shows one configuration for service provider station(s) 150 for a cell phone network. In the example of FIG. 1C, a first Base Transceiver Station (BTS) 152A and a second BTS 152B are in communication with a BSC 154 using the Abis interface. Each BTS 152 transmits wireless signals to and receives wireless signals from GSM handsets such as handset 110. BSC 154 performs a number of control functions for BTS 152A and 152B, including coordinating hand-offs between the two stations. One challenge in implementing UMA functionality without specially-enabled handsets is that the Abis interface is proprietary.

Accordingly, systems and techniques herein provide for a device that acts as a UMA proxy. Note that the UMA standard is outlined in specifications available at www.umatechnology.org/specifications/index.htm, and (for 3GPP) at www.3gpp.org/ftp/specs/archive/43 series/43.318 and www.3gpp.org/ftp/specs/archive/44 series/44.318. The specifications include UMA stage 1, R1.0, dated Sep. 1, 2004 (user perspective), UMA Stage 2, R1.0.4, dated May 16, 2005 (architecture), UMA Stage 3, R1.0.4, dated May 16, 2005, and UMA Mobile Conformance, R1.0.4, dated Jun. 22, 2005, 3GPPTS 43.318 V6.6.0, dated April 2006, and 3GPPTS 44.318 V6.5.0, dated May 2006, which are hereby incorporated by reference in their entirety.

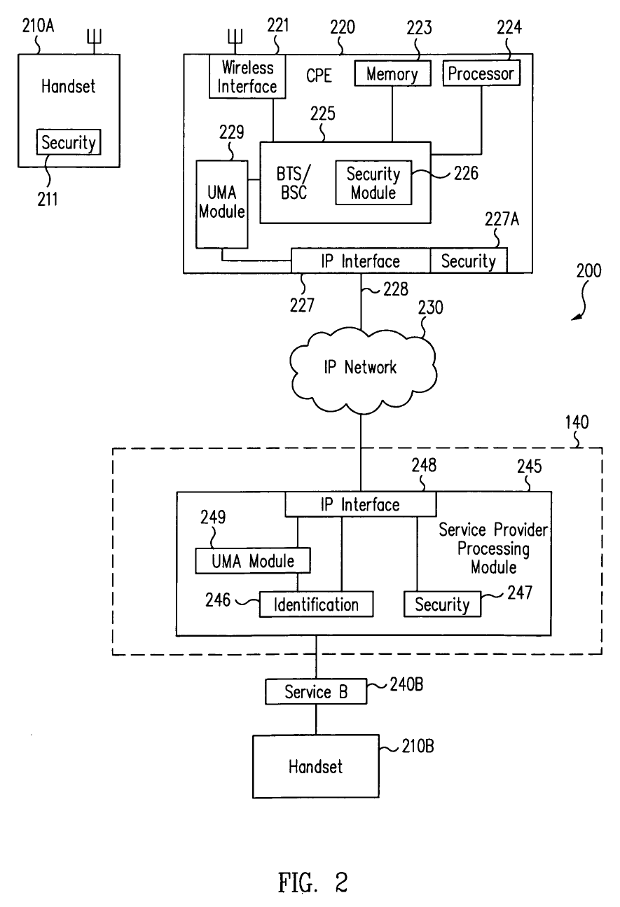

FIG. 2 shows an exemplary system 200 including a device (CPE) 220 that includes a BTS/BSC module 225 in communication with a wireless interface 221. BTS/BSC module 225 implements a number of functions, such as radio resource allocation (generally a BSC function), and layer one control (generally a BTS function). Since device 220 implements both BTS and a subset of BSC functionality, the proprietary Abis interface need not be used. Device 220 further includes a UMA module 229. UMA module 229 is shown as separate from BTS/BSC module 225; however, the modules may be at least partially integrated.

The UMA module implements UMA-RR procedures which are typically used to manage the broadband IP connection as well as providing transparent transport of upper layer messages (e.g., those defined in the mobility management and connection management messages in GSM 04.08).

System 200 illustrates a first end of the connection with a wireless handset 210A communicating with a handset 210B at the other end of the connection, using IP network 230. Handset 210B may be any type of handset (e.g., a cell phone, PSTN-connected handset, VoIP-connected handset, etc.) As shown in FIG. 2, handset 210B communicates with processing module 245 via a service B module, which may be a service provider network for the same service provider associated with handset 210B, a service provider network for a different service provider, etc.

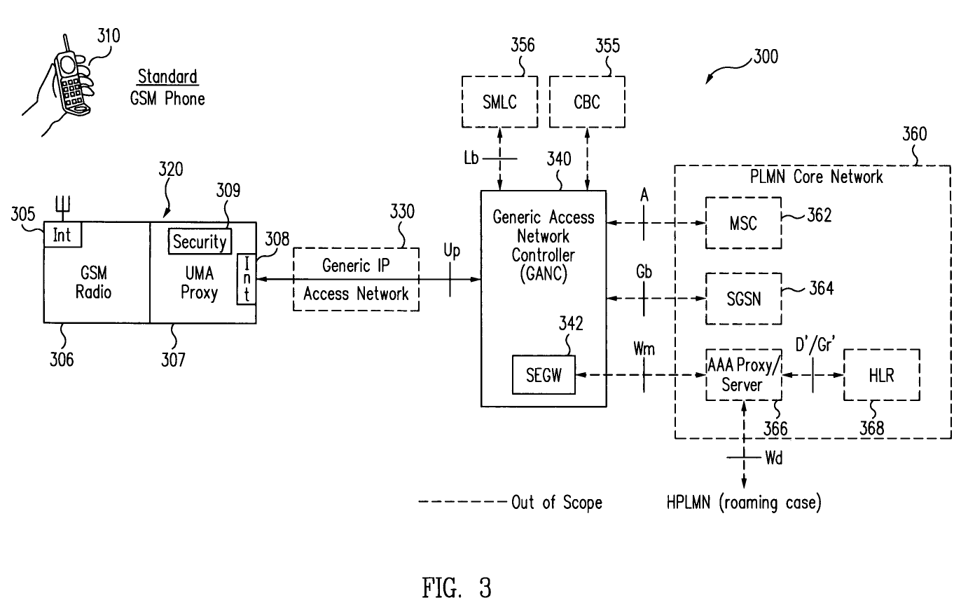

System 200 includes a service provider processing module 245 that receives and transmits packets for the connection between handset 210A and handset 210B over IP network 230. FIG. 2 illustrates the service provider system as a single module, for simplicity. Typically, service provider processing module 245 is implemented as more than one discrete entity. For example, FIG. 3 shows an implementation in which the service provider processing module includes a GANC controller, a Public Land Mobile Network (PLMN) core network, etc.

Like conventional cell phone network BTS/BSC apparatus, BTS/BSC module 225 is configured to generate and receive wireless signals indicative of voice and signaling information using licensed GSM frequency bands). Unlike a service provider BTS/BSC, however, device 220 is also configured to implement dual-mode functionality by transmitting and receiving voice and signaling information for handset 210A over an IP interface 227. IP interface 227 is configured to be connected to a public IP network 230 such as the Internet via the user's broadband connection 228.

One important challenge in dual mode systems is providing secure communications. In order to implement a security policy, IP interface module 227 is in communication with a security module 227a, which may be at least partially integrated with module 227. Security module 227a accesses an internal local key and security algorithms associated with device 220 (e.g., a secret key stored on and algorithms implemented in a Subscriber Identity Module or SIM card included in device 220) in order to protect the communications between BTS/BSC module 225 and service provider processing module 245.

Information received over IP interface 227 is processed using security module 227a to recover the transmitted information.

As described in more detail below (with reference to FIG. 3), security module 227a may provide for IPSec tunnel establishment between device 220 and service provider processing module 245, for secure transfer of voice and signaling information over IP network 230.

Information transmitted between handset 210A and CPE 220 must also be protected. In order to implement security on this link, keys and algorithms are negotiated between handset 210A and service provider processing module 245 (e.g., a ciphering key Kc associated with handset 210A and cipher algorithm A5/1). These are delivered from the service provider processing module 245 to the BTS/BSC module 225. BTS/BSC module 225 is in communication with a security module 226, which may be at least partially integrated with module 225. Security module 226 accesses the keys delivered from service provider processing module 245 associated with device 210A and utilizes the agreed algorithm in order to protect communications between CPE 220 and handset 210A.

In some embodiments, the UMA specification may be modified so that service provider processing module 245 receives a message to deliver the Kc of handset 210A to device 220 to be used for GSM encryption. Device 220 then retransmits the information received over the UMA network using an embedded radio TRX using existing GSM licensed frequencies.

Device 220 (e.g., BTS/BSC module 225, security module 226, etc.) may perform functions using hardware, firmware, software, or a combination. To do so, device 220 may include memory 223 to store data and/or instructions, and may include a processor 224 to execute instructions. Although memory 223 and processor 224 are shown as separate from BTS/BSC module 225 and security module 226, they may be at least partially integrated with one or more functional modules of device 220.

A service provider processing module 245 is also in communication with IP network 230, to transmit packets with voice and signaling information from handset 210B, and to receive the packets with voice and signaling information from handset 210A. As noted above, module 245 is typically implemented as a number of different elements, which may be co-located or located at different places.

In order to implement the current systems and techniques, module 245 receives packets on an IP interface 248, and first recovers signaling information indicative of the identification of device 220. Module 245 then verifies that device 220 is authorized to access the network of the service provider.

When handset 210A moves within range of device 220 it will act according to cellular specifications (e.g., GSM) and request the network update its location in the network. The handset 210A may additionally report neighbor cell information according to cellular specification. The request for network update signaling between handset 210A and device 220 will trigger security module 226 to send a registration message to service provider processing module 245, using the previously established secure link between IP interface 227 and module 245. The registration message may include an indication that the registration is from a licensed radio terminal rather than an un-licensed radio terminal and may include reported neighbor cell information, which may include a cell identifier for reported neighbor cells. Module 245 authenticates handset 210A and also verifies that handset 210A is authorized to access the network of the service provider using device 220 and may verify that the device 220 is allowed to be operatored in an area covered by the reported neighbor cells. Note that in some embodiments, only a subset of handsets associated with subscribers to the service provider are authorized to access the network of the service provider using device 220.

For example, module 245 includes an identification module 246 that accesses identification and other information for valid subscribers, including information such as the International Mobile Subscriber Identity (IMSI) for subscribers and associated secret key information. Identification module 246 further accesses information for devices (such as device 220) that are authorized to interface with one or more authorized users to provide access to the service provider network. The device information may include an IMSI associated with the particular device 220. The IMSI for each handset authorized to access the subscriber network using device 220 is associated with the IMSI for device 220, so that access is limited to certain subscribers.

Module 245 further includes a security module 247. Security module 247 may decrypt incoming packets received from device 220 over internet 230, the incoming packets including voice information transmitted from handset 210B, and may encrypt information to handset 210B to transmit over internet 230 towards device 220. In some implementations, an IPSec (Internet protocol security) tunnel may be established between security module 247 of service provider processing module 245 and security module 227a of device 220. Module 245 further includes a UMA module 249 (e.g., a Generic Access Network Controller or GANC). Although shown separate from security module 248, the modules may be at least partially integrated. For example, the embodiment of FIG. 3 illustrates an embodiment in which GANC 340 includes a security gateway (SEGW) 342 to provide secure access to the service provider network.

In operation, a user may activate handset 210A and initiate a connection to handset 210B. Device 220 receives wireless signals in the GSM spectrum from handset 210A, demodulates them and recovers those messages typically destined to the service provider voice network 140. It then transmits these over IP network 230 over a secure tunnel. Service provider processing module 245 receives packets from IP Network 230, and identification module 227a processes identification information contained therein. For example, identification module 246 may challenge handset 210A in order to verify the authenticity of handset 210A, to verify is associated with a valid subscription, and to verify that handset 210A is authorized to access the service provider network using device 220.

This may entail identification module 246 sending a challenge message towards handset 210A which transmitted over the IP network 230 and received by the BTS/BSC module 235 where the message is modulated within a wireless signal sent over the GSM spectrum. The corresponding response will traverse the return direction from handset 210A, BTS/BSC module 225, IP network 230 to identification module 246. As part of the authentication process, wireless security keys may be negotiated using the secret key in security module 247. Security keys are then delivered from module 245 to BTS/BSC module 225 in device 220. These keys are then used by wireless interface 221 in order to protect the wireless link between device 220 and handset 210A. The secure connection to handset 210B is then established, and voice and signaling information is transmitted between the two handsets using IP network 230.

FIG. 2 illustrates basic elements of a telecommunication system to implement the current techniques. FIG. 3 shows another exemplary system 300 to provide dual-mode functionality without the need for a dual-mode enabled handset. In FIG. 3, handset 310 is within range of a wireless device 320 (e.g., a CPE) which is configured to communicate with a group of specific GSM handsets and to act as a UMA proxy. Handset 310 includes a security module such as a SIM card with a local secret key (generally referred to as the authorization key Ki). Handset 310 also has an associated identifier such as an International Mobile Subscriber Identity (IMSI) to identify the handset (and thus the subscriber).

In system 300, device 320 includes a GSM radio module 306 including at least one antenna, signal processing circuitry, signal generation circuitry, data processor(s), memory, and/or other elements to receive, process, generate, and transmit wireless signals in the licensed GSM frequency bands.

Device 320 further includes a UMA proxy component 307. UMA proxy component 307 includes hardware, software, and/or firmware to interface with a generic IP access network 130 as a UMA proxy, and to interface with GSM radio module 306. UMA proxy component 307 may be at least partially integrated with module 306; that is, it may share elements such as data processing capability, memory, etc., with module 306.

UMA proxy component 307 of device 320 (in cooperation with other parts of system 300) also implements a security solution based on UMA/GAN, which uses IPSec (IP security) based on EAP-SIM (Extensible Authentication Protocol-Subscriber Identity Module). For example, UMA proxy component 307 includes a security module 309 including a SIM card with a local secret key associated with device 320. Device 320 has a unique identifier such as a Location Area Code that may be used in one or more location databases of components such as handset 310 or PLMN core network 360.

When voice and/or signaling information is received from handset 310, device 320 processes the information and generates packets to be transmitted to generic IP access network 330. At the service provider end of the communication, a Generic Access Network Controller (GANC) 340 receives the packets. GANC 340 includes a security gateway (SEGW) 342 to protect the service provider network.

GANC 340 is in communication with a Serving Mobile Location Center (SMLC) 350, which implements functionality to support Location Services (LCS). SMLC 350 manages co-ordination and scheduling of resources required for the location of handset 310. SMLC 350 is also in communication with a Cell Broadcast Center (CBC) 355. CBC 355 generates cell broadcast information.

GANC 340 transmits information to and receives information from PLMN core network 360. PLMN core network 360 is the Public Land Mobile Network (PLMN) in which the subscriber's profile is held (HPLMN) or a different (visitor) PLMN.

PLMN core network 360 includes a Mobile Switching Center (MSC) 362, Serving General Packet Radio Service Support Node (SGSN) 364, an Access, Authorization, Accounting (AAA) Proxy Server 366, and a Home Location Register (HLR) 368. According to some embodiments, AAA proxy server 366 is provisioned with IMSIs which are allowed to access service provider network 140 via device 320.

MSC 362 is a switching center in the service provider network architecture that interacts with one or more location databases. SGSN 364 keeps track of the location of handset 310, and performs security functions and access control.

AAA proxy server 366 is used to securely determine the identity and privileges of the subscriber, and to track the subscriber's activities. HLR 368 maintains subscription information.

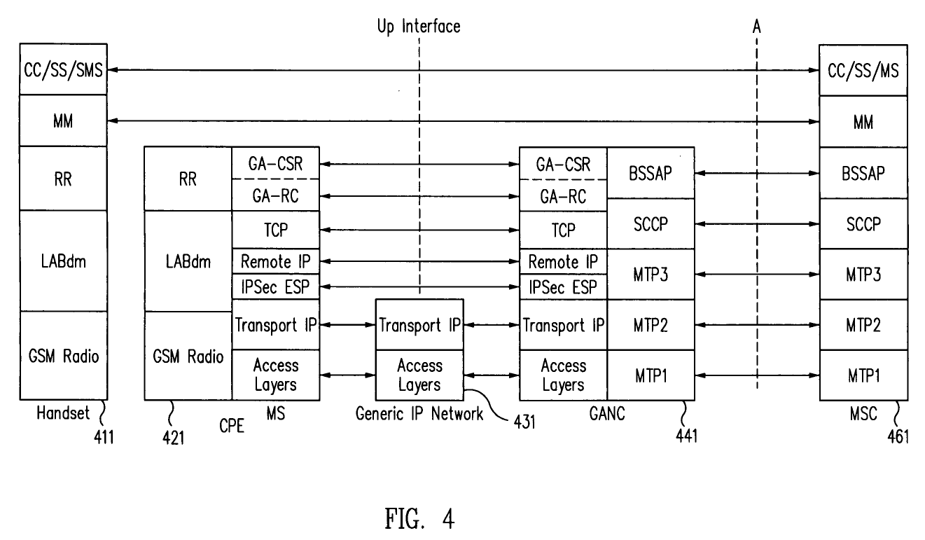

FIG. 4 shows an embodiment of a control system control protocol for system 300, for different layers. Handset protocols 411 are shown in the first block, CPE protocols 421 are shown in the second block, IP network protocols 431 are shown in the third block, GANC protocols 441 are shown in the fourth block, and MSC protocols 461 are shown in the fifth block.

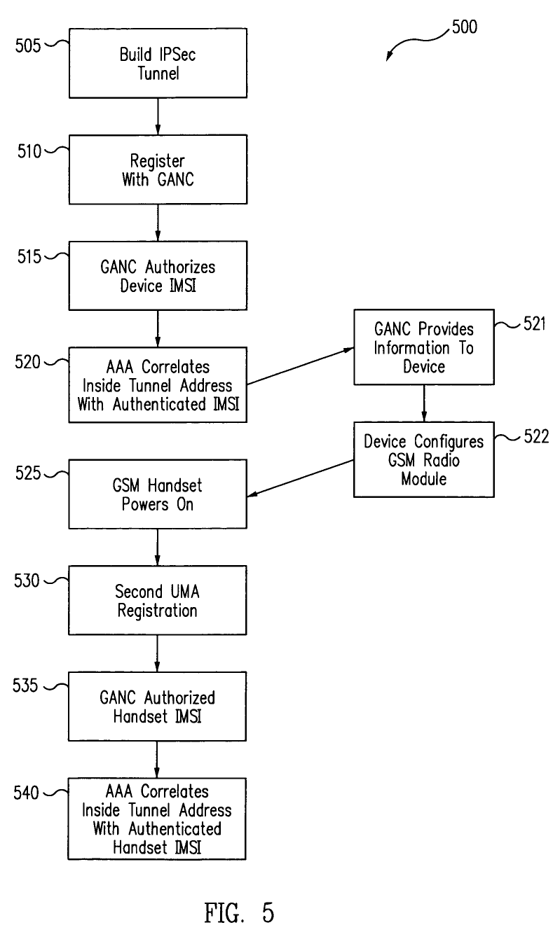

System 300 of FIG. 3 may be used to provide secure communication over the Internet. FIG. 5 is a diagram of a method 500 for a location update security solution, according to some embodiments. Referring to FIGS. 3 and 5, at 505, device 320 builds an IPSec tunnel to SEGW 342 of GANC 340. At 510, device 320 registers with GANC 340. At 515, GANC 340 authorizes the IMSI associated with device 320. At 520, AAA proxy server 366 correlates the inside tunnel address with an authenticated IMSI. Device 320 may send keep alives to ensure that the IPsec tunnel is permanently established and not torn down due to inactivity.

At 521, GANC 340 provides device 320 with information to enable it to configure its system information broadcast. At 522, device 320 configures GSM radio module 306 to begin broadcasting system information on the GSM Spectrum.

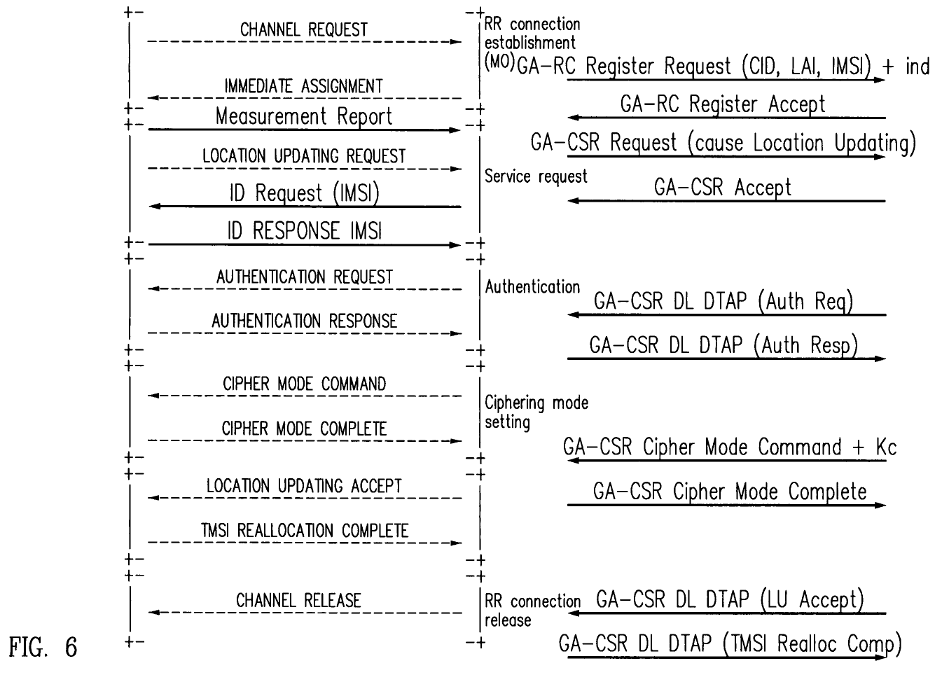

At 525, GSM handset 310 powers on and scans for broadcast system information. Having detected licensed radio broadcast from device 320, it performs a location update request to GSM module 306 of device 320. This triggers a second UMA registration with GANC 340, at 530. At 535, GANC 340 authorizes the IMSI of GSM handset 310 from the inside tunnel address. At 540, AAA proxy server 366 correlates the inside tunnel address with the IMSI associated with GSM handset 310, and confirms that the associated user profile indicates that the IMSI is allowed to access service provider network 140 using device 320. FIG. 6 shows the interworking between GSM and UMA for location updating, in detail.

As shown in the figures and described above, a wireless device allows cell phone access to a service provider network using an IP network such as the Internet, without requiring a subscriber to obtain new equipment. The service provider apparatus is configured to ensure that only authorized wireless devices access the network, and that any handsets accessing through a particular wireless device are authorized to do so. Finally, a security solution is provided to maintain a secure communication link.

In implementations, the above described techniques and their variations may be implemented at least partially as computer software and/or firmware instructions. Such instructions may be stored on one or more machine-readable storage media or devices and are executed by, e.g., one or more computer processors, or cause the machine, to perform the described functions and operations.

A number of implementations have been described. Although only a few implementations have been disclosed in detail above, other modifications are possible, and this disclosure is intended to cover all such modifications, and most particularly, any modification which might be predictable to a person having ordinary skill in the art.

Also, only those claims which use the word “means” are intended to be interpreted under 35 USC 112, sixth paragraph. Moreover, no limitations from the specification are intended to be read into any claims, unless those limitations are expressly included in the claims. Accordingly, other embodiments are within the scope of the following claims.

What is claimed is:

1. An apparatus comprising:
a wireless interface operable to communicate with a mobile endpoint over one or more wireless links in one or more licensed frequency bands, the communication between the wireless interface and the mobile endpoint comprising voice information and signaling information;
a network interface coupled to the wireless interface and operable to communicate with a network, the communication between the network interface and the network comprising packets comprising data representing the voice information and the signaling information; and
a security module coupled to the network interface comprising a fixed part and a removable part, the security module operable to:
access a first key associated with a particular mobile endpoint authorized to access a wireless service provider network using the apparatus, wherein the particular mobile endpoint is included in an authorized subset of mobile endpoints associated with subscribers to the wireless service provider;
access a second key associated with the apparatus, wherein the second key is included in the removable part of the security module; and
perform one or more security operations using the first key and the second key or both.

2. The apparatus of claim 1, wherein the removable part of the security module comprises a subscriber identity module (SIM) card.

3. The apparatus of claim 1, wherein the security module is operable to build an Internet Protocol Security (IPSec) tunnel to a security gateway in communication with the wireless service provider network.

4. The apparatus of claim 1, wherein the apparatus is operable to transmit an identifier to a controller in communication with the wireless service provider network.

5. The apparatus of claim 1, wherein the one or more licensed frequency bands comprise one or more licensed Global System for Mobile Communications (GSM) frequency bands.

6. The apparatus of claim 1, wherein the authorized subset of mobile endpoints associated with subscribers to the wireless service provider is a plurality of mobile endpoints comprising the particular mobile endpoint.

7. The apparatus of claim 1, wherein the one or more security operations comprise:
receiving the packets over the network interface; and
decrypting the packets.

8. The apparatus of claim 1, wherein the one or more security operations comprise:
receiving data indicative of voice information and the signaling information received on the wireless interface from the particular mobile endpoint; and
encrypting the data indicative of the voice information and the signaling information received on the wireless interface.

9. A system comprising:
an interface operable to receive data packets from an IP (Internet Protocol) network, the data packets comprising information indicative of a mobile endpoint identifier associated with a particular mobile endpoint and a wireless device identifier associated with a particular wireless device; and
an identification module operable to:
verify that the mobile endpoint identifier is associated with a valid subscriber of a particular telecommunications service provider associated with the system;
verify that the wireless device identifier is associated with a wireless device authorized to provide access to the system of the particular service provider; and
verify that the mobile endpoint identifier is associated with a subscriber authorized to access the system of the particular service provider using the particular wireless device;
receive information indicative of one or more cell identities received by the mobile endpoint, the one or more cell identities each associated with a cell operating in a particular area; and
verify that the mobile endpoint is authorized to operate in the area covered by one or more cells associated with the one or more cell identities.

10. The system of claim 9, wherein the system further comprises a security module operable to establish a secure tunnel to the particular wireless device over the IP network.

11. The system of claim 9, wherein the identification module comprises an access, authorization, accounting proxy server.

12. The system of claim 9, wherein the system further comprises information indicative of a ciphering key associated with the particular mobile endpoint, wherein the particular wireless device comprises a customer premises equipment (CPE) device, and wherein the telecommunications system is operable to transmit the information indicative of the ciphering key to the particular CPE device.

13. The system of claim 9, wherein the system comprises:
a generic access network controller (GANC) comprising a security gateway (SEGW); and
a public land mobile network in communication with the GANC, and wherein the security gateway is operable to establish a secure connection to the particular wireless device.

14. The system of claim 9, wherein the particular wireless device comprises an authenticated CPE device that has been verified as authorized to provide access to the system of the particular service provider, and wherein the system further comprises information for configuring system information to be broadcast from the authenticated CPE device, and wherein the telecommunications system is operable to transmit the information to the authenticated CPE device.

15. A method comprising:
receiving information indicative of a first key associated with a particular mobile endpoint, wherein the particular mobile endpoint is included in a subset of mobile endpoints associated with subscribers to a particular service provider that are authorized to access a telecommunications system using a particular wireless device;
receiving wireless signals in one or more licensed frequency bands from the particular mobile endpoint at the particular wireless device, the wireless signals comprising signaling information for a telecommunications connection between the particular mobile endpoint and the telecommunications system;
using a first key associated with the particular mobile endpoint to process at least some of the signaling information included in the received wireless signals to generate processed signaling information;
using a second key associated with the particular wireless device to encrypt at least some of the processed signaling information to generate encrypted processed signaling information, wherein the second key is included in a removable portion of a security module of the particular wireless device; and
transmitting the encrypted processed signaling information.

16. The method of claim 15, wherein transmitting the encrypted processed signaling information comprises transmitting the encrypted processed signaling information over a secure tunnel connection to an IP network.

17. The method of claim 16, further comprising:
receiving data packets comprising voice information to be transmitted to the particular mobile endpoint, the data packets received over the secure tunnel connection to the particular wireless device;
using the first key to protect the voice information; and
generating wireless signals in one or more licensed wireless frequency bands, the wireless signals indicative of the protected voice information.

18. A method comprising:
receiving data packets comprising information indicative of an identifier of a particular mobile endpoint, the data packets further comprising information indicative of an identifier of a particular wireless device;
verifying that the particular mobile endpoint is authorized to access a service provider network using the identifier of the particular mobile endpoint;
verifying that the particular wireless device is authorized to access the service provider network using the identifier of the particular wireless device;
verifying that the particular mobile endpoint is included in a group of mobile endpoints authorized to access the service provider network using the particular wireless device;
receiving information indicative of one or more cell identities received by the particular mobile endpoint, the one or more cell identities each associated with a cell operating in a particular area; and
verifying that the particular mobile endpoint is authorized to operate in the area covered by one or more cells associated with the one or more cell identities.

19. The method of claim 18, further comprising establishing a secure tunnel between the service provider network and the particular wireless device, and wherein the particular wireless device is a CPE device.

20. An apparatus comprising:
means for communicating with a particular mobile endpoint over one or more wireless links in one or more licensed frequency bands, the communication comprising voice information and signaling information;
means for communicating with a network, the communication comprising packets comprising data representing the voice information and the signaling information;
means for receiving information indicative of a first key associated with the particular mobile endpoint, wherein the particular mobile endpoint is included in a subset of mobile endpoints associated with subscribers to a particular service provider that are authorized to access the telecommunications system using a particular wireless device;
means for accessing a second key associated with the apparatus, wherein the second key is included in a removable portion of the apparatus; and
means for performing one or more security operations using the first key or the second key or both.

21. A system comprising:
means for receiving data packets from an IP network, the data packets comprising information indicative of a mobile endpoint identifier associated with a particular mobile endpoint and a wireless device identifier associated with a particular wireless device;
means for verifying that the mobile endpoint identifier is associated with a valid subscriber of a particular telecommunications service provider;
means for verifying that the wireless device identifier is associated with a wireless device authorized to provide access to the telecommunications system of the particular service provider;
means for verifying that the mobile endpoint identifier is associated with a subscriber authorized to access the telecommunications system of the particular service provider using the particular wireless device;
means for receiving information indicative of one or more cell identities received by the particular mobile endpoint, the one or more cell identities each associated with a cell operating in a particular area; and
means for verifying that the particular mobile endpoint is authorized to operate in the area covered by one or more cells associated with the one or more cell identities.
